(19) United States
(12) Patent Application Publication
(10) Pub. No.: US 2010/0138748 A1
(43) Pub. Date: Jun. 3, 2010

(54) Wireless Network Access to Remote Computer

(75) Inventors: Kunapareddy Sankararao, Guntur Andhrapradesh (IN); Seetharaman Vasu, Bangalore (IN)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/327,603

(22) Filed: Dec. 3, 2008

(51) Int. Cl. G06F 15/16; G06F 3/00

(52) U.S. Cl. 715/733; 709/227

(57) ABSTRACT

A wireless mobile device includes a processor configured to perform steps for accessing a remote computer. The steps performed by the processor include sending an access request to the remote computer using a transmitter to initiate a remote access session with the remote computer, and receiving display data from the remote computer in response to the access request using a receiver. The steps further include receiving user input data in response to the display data, and sending the user input data to the remote computer using the transmitter.

### BACKGROUND

1. Field

The subject technology generally relates to remote computer access, and more specifically to a method and apparatus for accessing a remote computer through a wireless network.

2. Background

A user may have files, e.g., documents, stored on a home computer, office computer, or other computer. While away from the computer, the user may wish to access a file stored on the computer, e.g., to edit the file and/or electronically send the file to a recipient. For example, in one scenario, the user may be on travel and unable to reach the computer to finish a business proposal stored on the computer. Without access to the business proposal, the user may be unable to submit the business proposal to a potential client in time, and may risk losing business as a result.

### SUMMARY

In one aspect of the disclosure, a wireless mobile device includes a receiver, a transmitter, and a processor configured to perform steps for accessing a remote computer. The steps performed by the processor include sending an access request to the remote computer using the transmitter to initiate a remote access session with the remote computer, and receiving display data from the remote computer in response to the access request using the receiver. The steps further include receiving user input data in response to the display data, and sending the user input data to the remote computer using the transmitter.

In another aspect of the disclosure, a method for accessing a remote computer from a wireless mobile device includes sending an access request to the remote computer to initiate a remote access session with the remote computer using a transmitter, and receiving display data from the remote computer in response to the access request using the receiver. The method further includes receiving user input data in response to the display data, and sending the user input data to the remote computer using the transmitter.

In another aspect of the disclosure a wireless mobile device includes means for receiving, means for transmitting, means for sending an access request to a remote computer to initiate a remote access session with the remote computer using the means for transmitting, and means for receiving display data from the remote computer in response to the access request using the means for receiving. The wireless mobile device further includes means for receiving user input data in response to the display data, and means for sending the user input data to the remote computer using the transmitter.

In another aspect of the disclosure a machine-readable medium includes instructions executable by a processing system in an electronic device. The instructions include code for sending an access request to the remote computer to initiate a remote access session with the remote computer using a transmitter, and receiving display data from the remote computer in response to the access request using a receiver. The instructions further include code for receiving user input data in response to the display data, and sending the user input data to the remote computer using the transmitter.

In another aspect of the disclosure a system for providing remote computer access includes a receiver, a transmitter, and a processor configured to perform steps for providing remote access to a computer. The steps include receiving an access request from a wireless mobile device using the receiver, and sending display data from the computer to the wireless mobile device in response to the access request using the transmitter. The steps further include receiving user input data from the wireless mobile device in response to the display data using the receiver, and sending the received user data to the computer.

In another aspect of the disclosure, a method for providing remote access to a computer includes receiving an access request from a wireless mobile device using a receiver, and sending display data from the computer to the wireless mobile device in response to the access request using a transmitter. The method further includes receiving user input data from the wireless mobile device in response to the display data using the receiver, and sending the received user input data to the computer.

In another aspect of the disclosure, a system for providing remote access to a computer includes means for receiving an access request from a wireless mobile device using a receiver, and means for sending display data from the computer to the wireless mobile device in response to the access request using a transmitter. The system further includes means for receiving user input data from the wireless mobile device in response to the display data using the receiver, and means for sending the received user input data to the computer.

In another aspect of the disclosure, a machine-readable medium comprising instructions executable by a processing system in an electronic device. The instructions include code for receiving an access request from a wireless mobile device using a receiver, and sending display data from the computer to the wireless mobile device in response to the access request using a transmitter. The instructions further include code for receiving user input data from the wireless mobile device in response to the display data using the receiver, and sending the received user input data to the computer.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

FIG. 1A is a conceptual block diagram illustrating an example of a network.

FIG. 1B is a conceptual block diagram illustrating an example of a network including a cellular network.

FIG. 2 is a conceptual block diagram illustrating another example of a network.

FIG. 3 is a conceptual block diagram illustrating an example of a mobile wireless device.

FIG. 4 is a conceptual block diagram illustrating an example of a mobile wireless device and a display/input adapter.

FIG. 5 is a conceptual diagram showing an example of a display/input adapter.

FIG. 6 is a conceptual block diagram illustrating an example of a computer and a wireless adapter.

FIG. 7 is a flowchart showing an example of a process for establishing a remote access session at the wireless mobile device end.

FIG. 8 is a flowchart showing an example of a process for selecting a remote computer.

FIG. 9 is a flowchart showing an example of a process for establishing a remote access session at the remote computer end.

FIG. 10 is a flowchart showing an example of a process for operating a wireless adapter in a remote computer access mode or a mobile phone mode.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

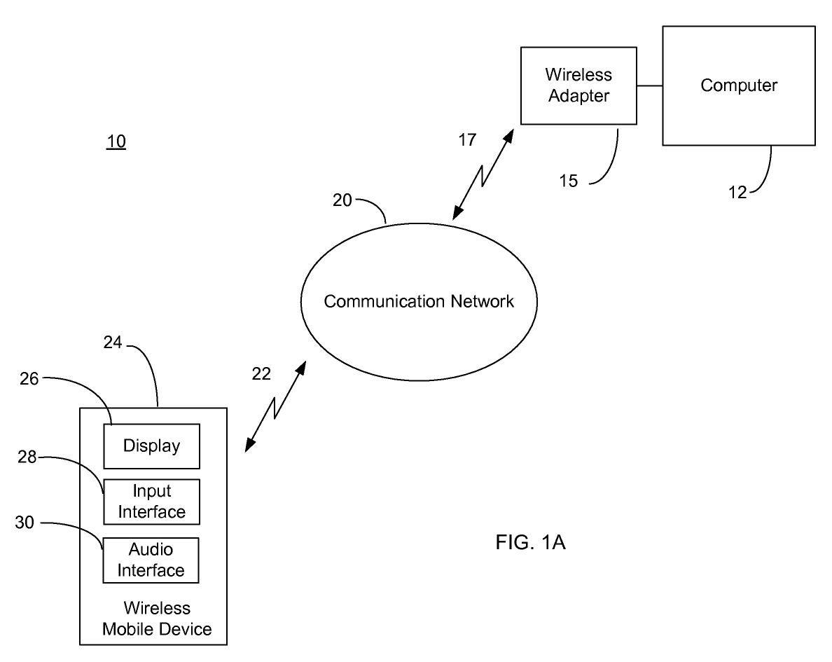

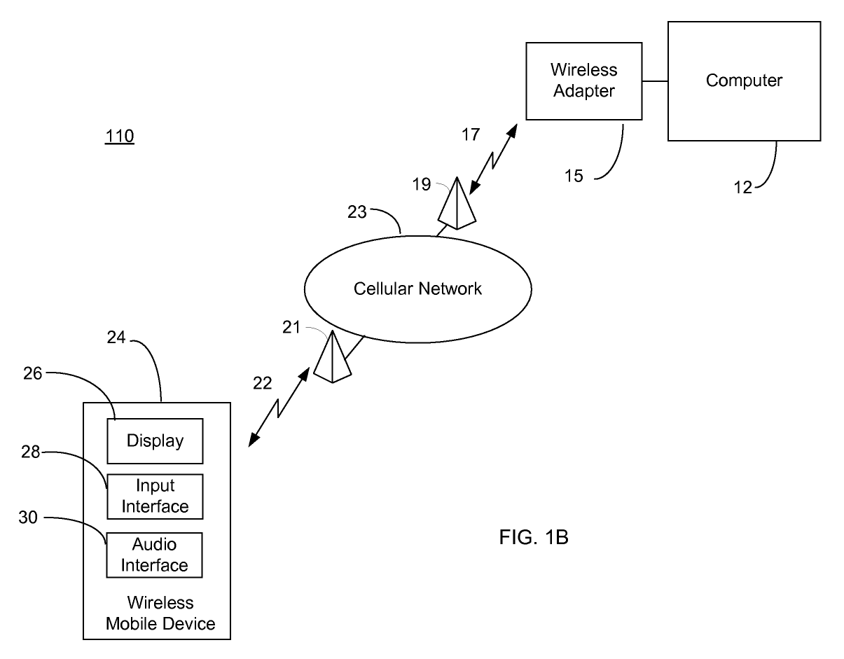

FIG. 1A is a conceptual block diagram illustrating an exemplary network 10 for providing remote access to a computer 12. The computer 12 may be a desktop computer, a laptop computer, a workstation computer, or other computer to which a user may desire remote access. The network 10 may comprise a wireless adapter 15 coupled to the computer 12 and a communication network 20. The communication network 20 may comprise a Wireless Wide Area Network (WWAN), a Code Divisional Multiple Access (CDMA) network, a Global System for Mobile communication (GSM) network, a Time Division Multiple Access (TDMA) network, a Frequency Division Multiple Access (FDMA) network, an Orthogonal Frequency Division Multiple Access (OFDMA) network, or any other communication network. The wireless adapter 15 may be configured to establish a wireless link 17 between the computer 12 and the communication network 20.

The network 10 may further comprise a wireless mobile device 24 configured to communicate with the communication network 20 via a wireless link 22. The wireless mobile device 24 may be a cellular phone, a personal digital assistant (PDA), a pager, a data transceiver, or any other suitable wireless mobile device. The wireless mobile device 24 may include a user input interface 28 for receiving user inputs. The user input interface 28 may include a keypad, touch screen, touchpad, a combination thereof, or any other suitable input interface. The wireless mobile device 24 may also include a display 26 for displaying information to the user. The display 26 may be a Liquid Crystal Display (LCD), an Organic Light Emitting Diode (OLED) display, or any other suitable display. The wireless mobile device 24 may further include an audio interface 30 for outputting audio information to the user and/or receiving audio input from the user. The audio interface 30 may be a speaker, a microphone, a wireless handset, a combination thereof, or any other suitable audio interface.

The network 10 may allow a user at the wireless mobile device 24 to remotely access the computer 12 from a location within coverage of the communication network 20. For an example where the communication network 20 comprises a cellular network, the wireless mobile device 24 may initiate a remote session with the computer 12 by calling a phone number associated with the wireless adapter 15. After the communication link is established, the computer 12 may send data to and receive data from the wireless mobile device 24 over the communication link to provide the user at the wireless mobile device 24 with remote access to the computer 12.

FIG. 1B shows an example where the communication network 20 in FIG. 1A comprises a cellular network 23. In this example, the cellular network 23 may include a first base station 21 that communicates with the wireless mobile device 24 via wireless link 22 and a second base station 19 that communicates with the wireless adapter 15 via wireless link 17. It is to be understood that the cellular network 23 may include one or more wireless and/or land links interconnecting the two base stations 19, 21. To initiate a remote access session in this example, the wireless mobile device 24 may call a phone number associated with the wireless adapter 15. The phone number may include a three digital area code followed by a seven digit number. The call may be received by the first base station 21 of the cellular network 23 via wireless link 22. The cellular network 23 may then route the call to the second base station 19 based on the phone number. The second base station 19 may then transmit the call to the wireless adapter 15 via wireless link 17. The wireless adapter 15 may automatically answer the call originating from the wireless mobile device 24 to establish a communication link between the wireless mobile device 24 and the computer 12 via the cellular network 21.

In one aspect of the disclosure, the computer 12 may send display data to the wireless mobile device 24. The wireless mobile device 24 may display the received display data on display 26 or other display to provide the user at the wireless mobile device 24 with a visual interface to the remote computer 12. As an example, the display data may include the display output of one or more applications, e.g., word processing application, running on the remote computer 12. The display data may be in a bitmap format or other format.

As an example, the display data may comprise “screen shots” of a computer screen at the remote computer 12. In this example, the computer 12 may periodically capture and send “screen shots” to the wireless mobile device 24 to provide the user at the wireless mobile device 24 with a graphical user interface that may be the same or similar to what a user located at the remote computer 12 would experience. The computer 24 may send the “screen shots” at a reduced resolution based on the resolution capabilities of the display 26.

The computer 12 may also send audio data to the wireless mobile device 24 for output to the user on the audio interface 30. For the example where the communication network comprises a cellular network, the audio and display data may be transported on a voice and data channel (e.g., traffic channel) of the cellular network.

In the reverse direction, the mobile wireless device 24 may send user input data to the computer 12 over the communication link to allow the user to input user commands to the computer 12 using the user input interface 28. Upon receiving the user input data, the computer 12 may respond according to the received input data. When user input data results in a change on a computer screen at the computer 12, the computer 12 may send display data, e.g., a “screen shot,” to the wireless mobile device 24 reflecting the change on the computer screen.

The user input data may include text entered by the user, movements of a pointer made by the user, etc. As an example, for user input data directing the movements of a pointer or cursor on a computer screen, the computer 12 may move the pointer or cursor accordingly. In this example, the user may use the user input interface 28 to remotely move a pointer, e.g., within a windows-based environment to open applications, files, etc., stored on the computer 12. When a file is open, e.g., on a word processing application running on the computer 12, the user may use the user input interface 28 to remotely edit the file and save changes made to the file during a remote session.

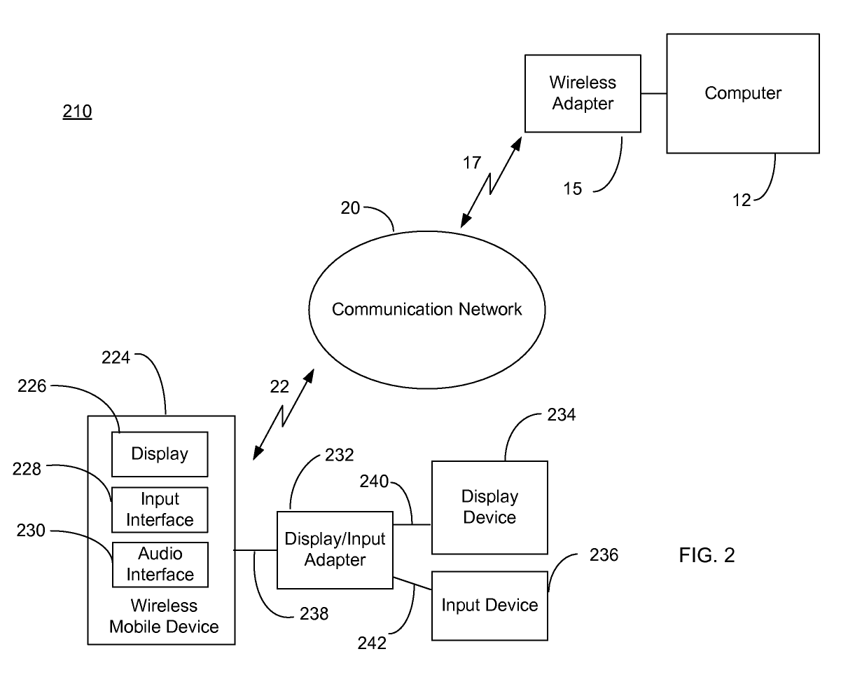

FIG. 2 is a conceptual block diagram of a network 210 according to another aspect of the disclosure. The network 210 may comprise a wireless mobile device 224, which may include a display 226, a user input interface 228, and an audio interface 230. The network 210 may further comprise a display device 234, a user input device 236, and a display/input adapter 232 interfacing the display device 234 and the input device 236 to the wireless mobile device 224. The display/input adapter 232 may be coupled to the wireless mobile device 224 by one or more links 238, which may comprise a Universal Serial Bus (USB), a FireWire cable, a Universal Asynchronous Receiver/Transmit (UART) link, an RF link, a Bluetooth link, an infrared link, a combination thereof, or any other suitable link.

The display device 234 may be an LCD, a OLED display, Cathode Ray Tube (CRT) display, or other suitable display. The wireless mobile device 224 may send display data received from the remote computer 12 to the display/input adapter 232. The display/input adapter 232 may process display data received from the wireless mobile device into a video signal for display on the display device 234. The video signal may be in any video format including Digital Visual Interface (DVI), Video Graphics Array (VGA), composite video, S-video or other suitable video format. The link 240 between the display/input adapter 232 and the display device 234 may be a DVI cable, a VGA cable, composite video cables, an S-video cable, or any other suitable link.

The input device 236 may be a keyboard, a mouse, a trackball, a combination thereof, or any other suitable input device. The link 242 between the display/input adapter 232 and the input device 236 may comprise a Universal Serial Bus (USB), a PS/2 link, a FireWire cable, an RF link, a Bluetooth link, an infrared link, a combination thereof, or any other suitable link. Upon receiving user input data from the input device 236, the display/input adapter 232 sends the user input data to the wireless mobile device 224. The wireless mobile device 224 may then send the user input data to the computer 12 through the communication network 20. More than one input device 236 may be coupled to the display/input adapter 232. As an example, both a keyboard and a pointing device may be coupled to the display/input adapter 232. In this example, the user may use the keyboard to enter text and the pointing device, e.g., a mouse, to move a pointer on a computer screen. The input device 236 may also be coupled to the wireless mobile device 224 without an adapter, e.g., when the input device 236 has an interface that is supported by the wireless mobile device 224, e.g., USB interface or Bluetooth interface.

In this aspect of the disclosure, the wireless mobile device 224 may be coupled to an external display device 234 through the adapter 232 to provide a larger screen size and/or a higher resolution than that provided by the display 226 of the wireless mobile device 224. The wireless device 224 may be coupled to an external input device 236 to provide a larger easier to use input interface and/or more user input options than that provided by the input interface 228 of the wireless mobile device 224. In this aspect, the wireless mobile device 224 may be more compact in size since the user may use the display device 226 and/or input device 236 to interface with the remote computer 12 through the wireless mobile device 224. In this aspect, the wireless mobile device 224 may act as a single point connecting device for remotely accessing the computer 12.

The networks described herein may allow a user at a wireless mobile device 24 and 224 to remotely access the computer 12, e.g., from an airport, a hotel, a restaurant, or any other location within coverage of the communication network 20. Once remote access is established, the user may remotely open and edit a document stored on the computer 12, save changes made to a document during a remote session, electronically send a document to a recipient, etc. The user may also watch a video stored on the computer 12, e.g., by remotely opening a video application on the computer 12 and playing the corresponding video file using the video application. Similarly, the user may listen to music stored on the computer 12, e.g., by remotely opening an audio application on the computer 12 and playing the corresponding audio file using the audio application.

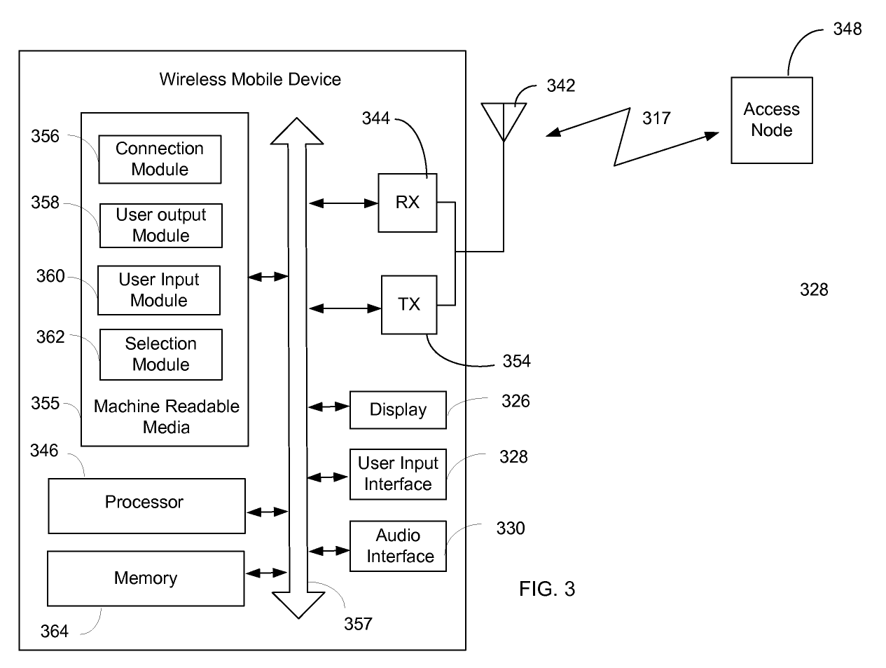

FIG. 3 is a conceptual block diagram of a wireless mobile device 324 according to an aspect of the disclosure. The wireless mobile device 324 may comprise a display 326, a user input interface 328, and an audio interface 330. The wireless mobile device 324 may also comprise an antenna 342, a receiver 344, a transmitter 354, and a processor 346. The antenna 342 may receive wireless signals from an access node 348 of the communication network 20. For an example where the communication network 20 comprises a cellular network, the access node 348 may be a cellular base station. The receiver 344 may amplify, filter, demodulate and/or frequency down-convert a received signal and output a signal to the processor 346 for further processing, e.g., decoding to recover display data and/or other data from the signal. The transmitter 354 may modulate, amplify and/or frequency up-convert a signal from the processor 346 for transmission from the antenna 342 to the access node 348. The processor 346 is capable of communication with the receiver 344 and transmitter 354 through a bus 357 or other structures or devices.

The processor 346 may be implemented using software, hardware, or a combination of both. Software shall be construed broadly to mean instructions, data, or any combination thereof, whether referred to as software, firmware, middleware, microcode, hardware description language, or otherwise. By way of example, the processor 346 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information. The wireless mobile device 324 may further comprise memory 364 that is operatively coupled to the processor 364 and can store information related to data processing.

In one aspect of the disclosure, the wireless mobile device 324 may comprise a machine readable media 355 that stores modules that may be executed by the processor 346 to provide remote computer access. The modules may include a connection module 356, a user output module 358, a user input module 360, and a computer selection module 362. During operation, the modules may be read from the machine readable media 355 and executed by the processor 346 to provide remote computer access. In one aspect, the modules may be loaded from the machine readable media 355 into memory 364, e.g., Dynamic Random Access Memory (DRAM), and executed by the processor from the memory 364. The processor 346 may communicate with the machine readable media through the bus 357 or other structures or devices.

The connection module 356 may initiate a remote session with the remote computer 12 and maintain a communication link with the remote computer 12 during the remote session. For an example where the communication network 20 comprises a cellular network, the connection module 356 may initiate a remote session by calling a phone number associated with the wireless adapter 15 and waiting for the remote computer 12 to respond through the wireless adapter 15. After the computer 12 responds, the connection module 356 may maintain a communication link with the remote computer 12 for the duration of the remote session. The connection module 356 may send authentication information, e.g., password, to the computer 12 to verify the user has permission to remotely access the computer 12.

The output module 358 may recover display data and/or audio data from a signal received by the receiver 344. The display data may include a header identifying the display data and the display module 358 may use the header to distinguish the display data from audio data recovered by the processor 346. The user output module 358 may process the recovered display data for display on the display 326 and output the processed display data to the display 326. The user output module 358 may also process recovered audio data and output the processed audio data to the audio interface 330.

The user input module 360 may receive user input data from the user input interface 328 and process the input data for transmission by the transmitter 354. The user input module 360 may append a header to the user input data identifying the user input data. The computer 12 may later use the header to distinguish the user input data from other data received by the computer 12.

The computer selection module 362 may allow a user to select a computer for remote computer access from multiple computers. For an example where the communication network 20 comprises a cellular network, the machine readable media 355 may store computer information for each of the multiple computers including a phone number associated with each computer. To select a computer, the computer selection module may display a list of computers available for remote access on the display 326. The computers may be identified by user assigned names (e.g., “home computer,” “office computer,” etc.) or other identifiers. The user may select one of the computers from the list using the user input interface 328. For example, the user may select a desired computer, e.g., by highlighting and clicking on a desired computer using a touch pad. When the user selects a computer, the selection module 362 may instruct the connection module 356 to initiate a remote session with the selected computer. For an example where the communication network 20 comprises a cellular network, the connection module 356 may retrieve the phone number associated with the selected computer from machine readable media 355, and call the phone number to establish a communication link with the selected computer. The phone numbers for the different computers may be stored in an address book for an example where the wireless mobile device 324 is a cellular phone.

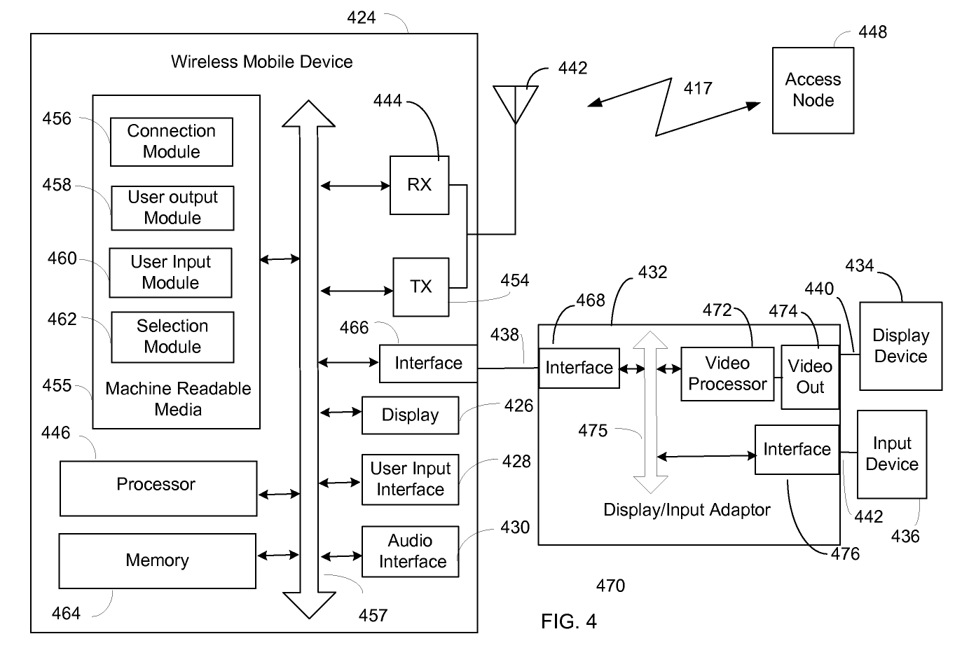

FIG. 4 is a conceptual block diagram of a wireless mobile device 424 according to another aspect of the disclosure. The wireless mobile device 424 may comprise a display 426, a user input interface 428, and an audio interface 430. The wireless device 424 may also comprise a processor 446, and a machine readable media 455 storing a connection module 456, a user output module 458, a user input module 460, and a selection module 462. The wireless mobile device 424 may also comprise a receiver 444, a transmitter 454, an antenna 442, a memory 464, and a bus 457 or other structure for providing communication among the various components of the wireless mobile device 424. The components in FIG. 4 may perform one or more of the functions discussed above for corresponding components in FIG. 3. The above components may also perform functions discussed further below. During operation, the modules may be loaded from the machine readable media 455 into memory 464, e.g., Dynamic Random Access Memory (DRAM), and executed by the processor 446 from the memory 464.

In this aspect of the disclosure, the wireless mobile device 424 may further comprise an interface 466. The interface 466 may be used for coupling the processor 446 to one or more external devices. The interface 466 may comprise a USB interface, a FireWire interface, a UART interface, an RF interface, a Bluetooth interface, an infrared interface, or any suitable interface.

A display/input adapter 432 may interface the wireless mobile device 424 to a display device 434 and an input device 434. The display/input adapter 432 may comprise an interface 468 corresponding to the interface 466 of the wireless mobile device 424 for transmitting data to and receiving data from the wireless mobile device 424. The display/input adapter 432 may further comprise a video processor 472, an interface 476, and a bus 475 or other structure for providing communication between the interfaces 476 and 466 and between the interface 466 and the video processor 472.

The video processor 472 may receive display data from the wireless mobile device 424 via interface 468 and process the display data into a video signal, which is outputted to the display device 434 from one or more video output ports 474. The video signal may be in any video format including Digital Visual Interface (DVI), Video Graphics Array (VGA), composite video, S-video or other suitable video format.

The interface 476 may be used for coupling the display/input adapter 432 to a user input device 436. The input device 436 may be a keyboard, a mouse, a trackball, a combination thereof, or any other suitable input device. The interface 476 may be a USB interface, a PS/2 interface, a FireWire interface, an RF interface, a Bluetooth interface, an infrared interface, a combination thereof, or any other suitable interface. The display/input adapter 432 may send user input data received from the input device 436 to the wireless mobile device 424 via interface 468. The input device 436 may also be coupled to the wireless mobile device 424 without an adapter if the input device 436 has an interface that is supported by the wireless mobile device 424, e.g., USB interface or Bluetooth interface.

According to an aspect of the disclosure, the user output module 458 recovers display data from a signal received by the receiver 444, and sends the recovered display data to the display/input adapter 430 through the interface 466 for display on the display device 432. The user input module 460 may receive user input data from the display/input adapter 430 through the interface 466 and processes the input data for transmission by the transmitter 454. The user input module 460 may append a header to the user input data identifying the user input data for the computer 12 to distinguish the input data from other data received by the computer 12. In this aspect, the wireless mobile device 424 may act as a single point connecting device through which display data from the remote computer 12 is sent to the display device 434 and user input data from the input device 436 is sent to the remote computer 12 for proving remote computer access. Since the display data in this aspect may not be displayed on the native display 426 of the wireless mobile device 424, the display data may be of a higher resolution than is capable of being displayed on the native display 426. In this aspect, the display data is recovered by the processor 446, e.g., from a cellular signal, and then forwarded to the display/input adapter 432, which processes the display data for display on the display device 426. This allows the wireless mobile device 424 to be very compact in size.

The user output module 458 may also generate display data for display on the display device 434. As an example, the user output module 458 may generate a display image showing a plurality of computers from which the user can select for remote access before a remote session has been establish. The plurality of computers may be identified in the display image by user assigned names (e.g., “home computer,” “office computer,” etc.) or other identifiers. In this aspect, the user output module 458 may retrieve the names of the available remote computers from a database stored in the machine readable media 455. The user output module 458 may send the generated display image to the display/input adapter 432 for display on the display device 434. In this aspect, the user output module 458 may detect when the display/input adapter 432 is coupled to the interface 466 of the wireless mobile device 424, and automatically send the display image to the display/input adapter 432 for display to the user. As an example, once the display/input adapter 432 is coupled to the wireless mobile device 424, a window may pop up on the display device 434 giving the user the option to remotely access one of a plurality of remote computers.

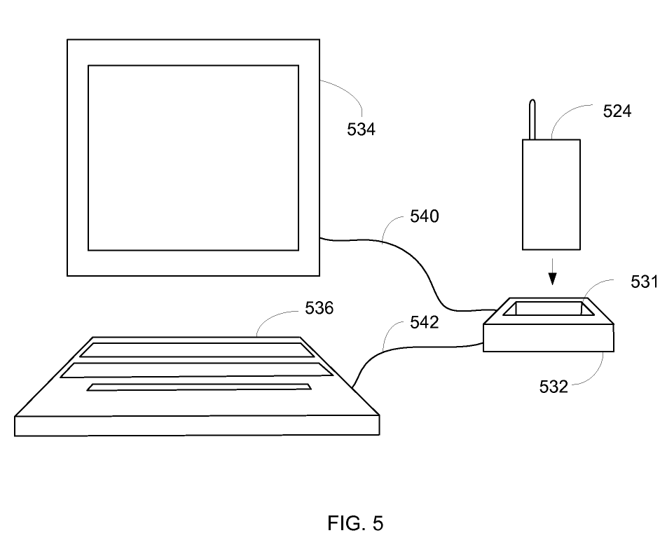

The display/input adapter 432 may include an outer housing having a holder that is designed to hold the wireless mobile device 424 therein. FIG. 5 shows an example of a display/input adapter 532 in the form of a docking station with a holder 531 for holding the wireless mobile device 524 therein. The display/input adapter 532 may include a socket or other connector (not shown) within the holder 531 for coupling the interfaces (not shown in FIG. 5) of the display/input adapter 532 and the wireless mobile device 524. The display/input adapter 532 may be coupled to a display device 534 via link 540, which may be a VGA cable, a DVI cable, or any other suitable link. The display/input adapter 532 may also be coupled to an input device 536 via link 542, which may be a USB cable, a wireless link, or any other suitable link. The wireless mobile device 524 may be orientated differently with respect to the display/input adapter 532 than shown in the example of FIG. 5. For example, the wireless mobile device 524 may be orientated on one of its sides when plugged into the display/input adapter 532.

In the example where the display/input adapter 532 is in the form of a docking station, the display/input adapter 532 may be automatically detected when the wireless mobile device 524 is inserted into the display/input adapter 532. This may be done by automatically connecting the display/input adapter 532 to the communication network 20 (e.g., cellular network) through the wireless mobile device 524.

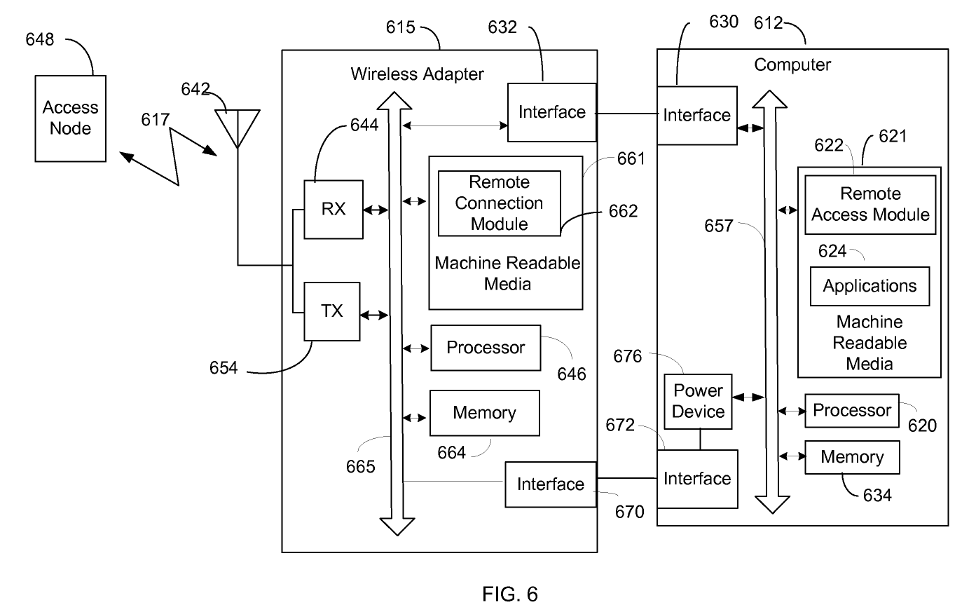

FIG. 6 is a conceptual block diagram of a computer 612 and a wireless adapter 615 according to an aspect of the disclosure. The computer 612 may be a desktop computer, a laptop computer, a workstation computer, or any other suitable computer. The computer 612 comprises a processor 620. The processor 620 may be implemented using software, hardware, or a combination of both. The computer 612 also comprises a machine readable media 621 that may store a remote access module 622 and one or more applications 624 that may be executed by the processor 620. The remote access module 622 controls remote access to the computer 612, as described further below. The applications 624 may comprise application programs, e.g., a word processing application, an electronic mail application, a multimedia player application, or any other application program. In one aspect, the module 622 and applications 624 may be loaded from the machine readable media 621 into memory 634, e.g., Dynamic Random Access Memory (DRAM), and executed by the processor 620 from the memory 634. The processor 620 may communicate with the machine readable media through the bus 657 or other structures or devices.

The computer 612 also comprises an interface 630 for coupling the processor 620 to the wireless adapter 615. The interface 630 may be a Personal Computer (PC) card slot, an ExpressCard slot, or other card slot. The interface 630 may also be a USB interface, an RF interface, a Bluetooth interface, or any other interface. The various components of the computer 612 may communicate with one another through the bus 657 or other structure or device.

The wireless adapter 615 comprises an antenna 642, a receiver 644, a transmitter 654, and a processor 646. The antenna 642 may receive wireless signals from an access node 648 of the communication network 20. For an example where the communication network 20 comprises a cellular network, the access node 648 may be a cellular base station. The receiver 644 may amplify, filter, demodulate and/or frequency down-convert the received signal and output a signal to the processor 646 for further processing, e.g., decoding the signal to recover user input data and/or other data from the signal. The transmitter 654 may modulate, amplify and/or frequency up-convert a signal from the processor 646 for transmission from the antenna 642. The processor 646 may communicate with the receiver and the transmitter 654 through a bus 665 or other structure or device.

The wireless adapter 615 also comprises a machine readable media 661 storing a remote connection module 662 that may be executed by the processor 646 for providing a remote connection to the computer 612 through the wireless adapter 615. In one aspect, the remote connection module 662 may be loaded from the machine readable media 661 into memory 664, e.g., Dynamic Random Access Memory (DRAM), and executed by the processor 646 from the memory 634. The processor 646 may communicate with the machine readable media through the bus 665 or other structures or devices.

The wireless adapter 615 may further comprise an interface 632 corresponding to the interface 630 of the computer 612 for coupling the wireless adapter 615 to the computer 612.

Although the computer 612 may be remotely accessed from any wireless mobile device described in the disclosure, various functions of the computer 612 will be described with reference to wireless mobile device 24 for ease of discussion.

In one aspect of the disclosure, the remote connection module 662 determines when the wireless mobile device 24 requests remote access to the computer 612 by monitoring wireless signals from the communication network 20. For an example where the communication network comprises a cellular network, the remote connection module 662 may periodically monitor signals from a cellular base station for calls. When the wireless adapter 615 receives a call initiated by the wireless mobile device 24, the remote connection module 662 may automatically answer the call to establish a communication link with the wireless mobile device 24 through the communication network 20. The remote connection module 662 may also check a Caller ID in a received signal to identify the wireless mobile device 24.

When a communication link is established with the wireless mobile device 24 through the communication network 20, the remote connection module 662 may inform the computer 612 that the wireless mobile device 24 has requested remote access to the computer 612. At this point, the remote access module 622 of the computer 612 may verify authentication information (e.g., password) from the wireless mobile device 24 before permitting remote access to the computer 612. If access is permitted, then the remote access module 622 may begin sending display data and/or audio data to the wireless adapter 615 and receiving user input data from the wireless adapter 615.

During a remote session, the remote access module 622 may send display data to the wireless adapter 615 for transmission to the wireless mobile device 24 through the communication network 20. The remote access module 622 may obtain the display data by capturing display outputs from one or more open applications 624. The remote access module 622 may also obtain the display data by capturing “screen shots,” e.g., from a display driver of the computer 612. The remote access module 622 may frequently capture and send “screen shots” to the wireless adapter 615 for transmission to the wireless mobile device 24 to keep the display at the wireless mobile device 24 fresh. The remote access module 622 may append a header to the display data identifying the display data. When the wireless adapter 615 receives display data from the computer 612, the remote connection module 662 may process the display data for transmission and send the processed display data to the transmitter 654 for transmission to the access node 648 of the communication network 20. The communication network 20 may then transmit the display data to the wireless mobile device 24 on the other side of the network 20.

In the reverse direction, the wireless adapter 615 may receive signals from the communication network 20 using the receiver 644. The remote connection module 662 may recover user input data and/or other data from a signal received by the receiver 644 and send the recovered user input data and other data to the computer 612 through the interface 630. Upon receiving the user input data, the remote access module 622 may direct the user input data to the appropriate application 624. The remote access module 622 may also direct the user input data to an input driver responsible for receiving and processing user inputs. The received user input data may include a header identifying the user input data and the remote connection module 662 may use the header to distinguish the user input data from other received data.

In one aspect of the disclosure, the computer 612 may comprise a power device 676 to allow the computer 612 to be remotely turned on when the computer 612 is turned off. The computer 612 may further comprise an interface 672 coupled to the power device 676. The interface 672 may be used to couple the power device 676 to the wireless adapter 615. The interface 627 may comprise an RF interface, an infrared interface, an Ethernet interface, a serial cable interface, or any other suitable interface. The interface 672 may be coupled to a corresponding interface 670 of the wireless adapter 615. The wakeup signal may be communicated using any type of wired/wireless communications protocol which can control a remote device.

In this aspect of the disclosure, the power device 676 may remain powered on using auxiliary power when the processor 620 and other components of the computer 612 are powered down. The auxiliary power be supplied from a battery that charges when the main power of the computer 612 is turned on. The auxiliary power may also be supplied from an electrical outlet when the main power is turned off. To enable remote turn on, the power device 676 may monitor the interface 647 for a wakeup signal from the wireless adapter 615. Upon receiving the wakeup signal, the power device 676 may turn on the processor 620 of the computer 612. The remote access module 622 may automatically launch when the processor 620 is turned on by the power device 676 and send a message to the wireless adapter 662 indicating that the remote access module 622 is ready to begin remote access.

The remote connection module 662 may remotely turn on the computer 612 when the remote connection module 662 fails to receive a response from the computer 612 or detects that the computer 612 is turned off through the interface 632. In this case, the remote connection module 662 may send a wakeup signal to the power device 676 through the interface 670. The remote connection module 662 may also send a message to the wireless mobile device 24 through the communication network 20 indicating that the computer 612 has been turned on. Upon receiving this message, the wireless mobile device 24 may display a message to the user that the remote computer 612 is powering up.

In one aspect of the disclosure, the wireless adapter 615 may also be used as a mobile phone (e.g., cellular phone) by a user at the wireless adapter 615. In this aspect, the wireless adapter 615 may further comprise a user input interface 670 (e.g., keypad and/or touch screen), a user output interface 672 (e.g., display and/or audio output), and one or more programs that may be executed by the processor 646 to enable mobile phone functions. The mobile phone functions may include, e.g., voice and data communication between users and/or text messaging between users. The programs may be stored in the machine readable media 661, memory 664 and/or memory internal to the processor 646. When the wireless adapter 615 is used as a mobile phone by a user, the user may initiate and receive calls and/or send and receive text messages using the user input and output interfaces 670 and 672.

In one aspect, the wireless adapter 615 may comprise a mode module 675 to operate the wireless adapter 615 in a remote computer access mode or a mobile phone mode. The mode module 675 may comprise one or more programs stored in the machine readable media 661 and executed by the processor 646. In the remote computer access mode, the wireless adapter 615 provides the wireless mobile device 24 with remote access to the computer 612 through the wireless adapter 615, as discussed above. In the mobile phone mode, the wireless adapter 615 may be used as a mobile phone by a user at the wireless adapter 615, e.g., to allow the user at the wireless adapter 615 to receive a call from a user at the wireless mobile device 24. In this example, the communication network 20 may comprise a cellular network supporting voice and data communication between the wireless mobile device 24 and the wireless adapter 615.

In this aspect, the mode module 675 may select the remote computer access mode or the mobile phone, e.g., based on a command in a phone call received from the wireless mobile device 24. In this example, the command may indicate whether the user at the wireless mobile device 24 wants to remotely access the computer 12 or communicate with the wireless adapter 615 in the mobile phone mode. The command may be in the form of a bit with the bit value indicating the remote computer access mode or the mobile phone mode. The command may be part of or accompany the phone number used to call the wireless adapter 615 and/or a command sent to the wireless adapter 615 after the wireless adapter 615 answers a call.

In this aspect, the wireless mobile device 424 in FIG. 4 may enable the user at the wireless mobile device 424 to select the remote computer access mode or the mobile phone mode when communicating with the wireless adapter 615. For example, the wireless mobile device 424 may allow the user to select the mode using a graphical user interface or any other type of user interface. When the user selects one of the modes, the connection module 456 may send a command indicating the selected mode to the wireless adapter 615, as discussed above.

For example, the user at the wireless mobile device 424 may select the mobile phone mode to call another user at the wireless adapter 615 instead of remotely accessing the computer 12. In this example, the connection module 456 sends a command indicating the mobile phone mode to the wireless adapter 615. Upon receiving the command, the wireless adapter 615 may initiate a ring on the user output interface 672 to indicate an incoming call to a user at the wireless adapter 615.

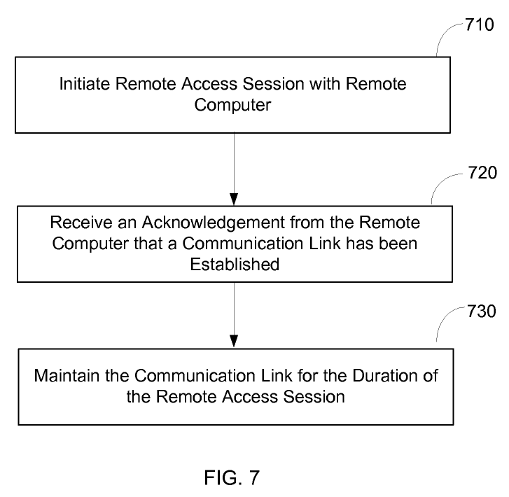

FIG. 7 shows a flowchart of a process that may be performed by the processors 364 and 464 of the wireless mobile devices in FIGS. 3 and 4 for establishing a remote access session with a remote computer. In step 710, the process initiates a remote access session with the remote computer 12. For the example where the communication network 20 comprises a cellular network, the process may call a phone number associated with the remote computer via the cellular network. In step 720, the process receives an acknowledgement from the remote computer 12 that a communication link has been established between the wireless mobile device and the remote computer 12. For the example of a cellular network, the acknowledgement may include a message indicating that the call has been answered at the remote computer's end and the remote computer 12 is ready to begin the remote access session. In another aspect, the remote computer 12 may request that the wireless mobile device send verification information before granting remote access. In step 730, the process maintains the communication link with the remote computer 12 for the duration of the remote access session. During the remote session, the wireless mobile device may receive display data (e.g., “screen shots”) from the remote computer 12 to provide the user at the wireless mobile device with a visual interface to the remote computer 12. Also, during the remote session, the wireless mobile device may receive inputs from the user at the wireless mobile device in response to the display data, and send the user input data to the remote computer 12.

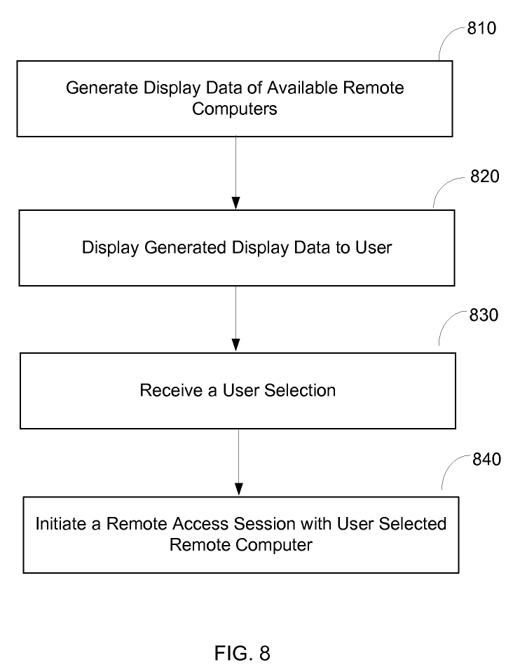

FIG. 8 shows a flowchart of a process that may be performed by the processor 464 of the wireless mobile device in FIG. 4 for selecting a remote computer for remote computer access. In step 810, the process generates display data showing a plurality of remote computers that may be available for remote computer access. The display data may include user assigned names (e.g., “home computer,” “office computer,” etc.) for the remote computers. The process may generate the display data by retrieving information on available remote computers from a database stored in machine readable media. In step 820, the process displays the generated display data on a display to show a user the available remote computers. The display may be an external display that is coupled to the wireless mobile device through an adapter. In this example, the process may automatically send the generated display data to the display upon detecting the presence of the external display. In step 830, the process receives a selection from the user. In step 840, the process initiates a remote access session with the user selected remote computer. For the example of a cellular network, the process may do this by retrieving a phone number associated with the selected remote computer from machine readable media, and calling the retrieved phone number to contact the selected remote computer.

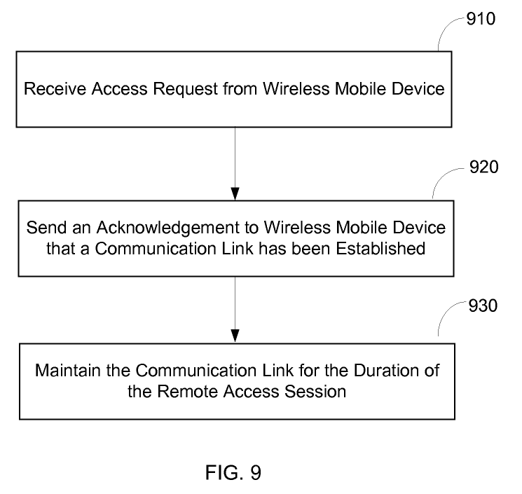

FIG. 9 shows a flowchart of a process that may be performed by the processors 664 and 620 in FIG. 6 for establishing a remote access session with a wireless mobile device. In step 910, the process receives an access request from a wireless mobile device attempting to remotely access the computer. For the example of a cellular network, the process may automatically answer a call originating from the wireless mobile device. In this example, the process may check a caller ID from the wireless mobile device to verify that the wireless mobile device is permitted to access the computer. In step 920, the process sends an acknowledgement to the wireless mobile device indicating that a communication link has been established between the wireless mobile device and the computer. At this point, the process may send a request to the wireless mobile device for verification information before granting remote access to the computer. In step 930, the process maintains the communication link with the wireless mobile device for the duration of the remote access session. During the remote session, the process may send display data (e.g., “screen shots” of the computer) to the wireless mobile device via the communication link. Also, during the remote session, the process may receive user input data from the wireless mobile device in response to the display data.

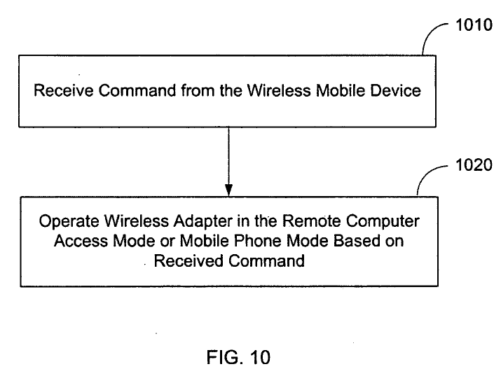

FIG. 10 shows a flowchart of a process that may be performed by the processor 664 in FIG. 6 for operating the wireless adapter 615 in the remote computer access mode or the mobile phone mode. In step 1010, the process receives a command from a wireless mobile device 24 indicating the remote computer access mode or the mobile phone mode. In step 1020, the process operates the wireless adapter 615 in the remote computer access mode or the mobile phone mode based on the received command.

The methodologies described herein may be implemented by various means depending upon the application. For example, these methodologies may be implemented in hardware, firmware, software or a combination thereof For a hardware implementation, the processors may be implemented within one or more application specific integrated circuits (ASICs), digital signal processors (DSPs), digital signal processing devices (DSPDs), programmable logic devices (PLDs), filed programmable gat arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine readable medium tangibly embodying instructions may be used in implementing the methodologies described herein. For example software codes may be stored in memory, for example the memories 364, 464, 664 and 634 and machine readable media 355, 455 621, 661, and executed by a processor, for example the processors 346, 446, 660 and 620. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored.

The memories described in the disclosure may comprise machine readable media. Machine readable media may include storage integrated into a processor, such as might be the case with an ASIC, and/or storage external to a processor. By way of illustration, and not limitation, readable media may include one or more of volatile memory, nonvolatile memory, a Random Access Memory (RAM), a flash memory, a Read Only Memory (ROM), a Programmable Read-Only Memory (PROM), an Erasable PROM (EPROM), a register, a hard disk, a removable disk, a CD-ROM, a DVD, or any other suitable storage device. In addition, readable media may include a transmission line or a carrier wave that encodes a data signal. A readable medium may be a machine readable media encoded or stored with a computer program or instructions. The computer program or instructions may be executable by a transmitter or receiver device or by a processor of a transmitter or receiver device.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

Examples of particular communications protocols and formats have been given to illustrate the subject technology. However, the subject technology is not limited to these examples and applies to other communications protocols and formats.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A wireless mobile device, comprising:
a receiver;
a transmitter; and
a processor configured to perform steps for accessing a remote computer, the steps comprising:
sending an access request to the remote computer using the transmitter to initiate a remote access session with the remote computer;
receiving display data from the remote computer in response to the access request using the receiver;
receiving user input data in response to the display data; and
sending the user input data to the remote computer using the transmitter.

2. The wireless mobile device of claim 1, wherein the processor is configured to send the access request to the remote computer via a cellular network.

3. The wireless mobile device of claim 2, wherein the step of sending an access request to the remote computer comprises calling a phone number associated with the remote computer via the cellular network.

4. The wireless mobile device of claim 1, wherein the steps performed by the processor further comprise sending the received display data to a video adapter for display on an external display device.

5. The wireless mobile device of claim 4, wherein the steps performed by the processor further comprise generating display data identifying a plurality of remote computers, and sending the generated display data to the video adapter for display on the display device.

6. The wireless mobile device of claim 5, wherein the steps performed by the processor further comprise receiving a user selection, and initiating a remote access session with one of the plurality of remote computers based on the received user selection.

7. The wireless mobile device of claim 6, wherein the steps performed by the processor further comprise detecting a presence of the video adapter, and automatically sending the generated display data to the video adapter upon detecting the presence of the video adapter.

8. The wireless mobile device of claim 1, wherein the wireless mobile device accesses the remote computer through a wireless adapter, and the steps performed by the processor further comprise receiving a mode selection from a user, and sending a command to the wireless adapter to operate in a remote computer access mode or a mobile phone mode based on the mode selection.

9. A method for accessing a remote computer from a wireless mobile device, the wireless mobile device comprising a receiver and a transmitter, the method comprising:
sending an access request to the remote computer to initiate a remote access session with the remote computer using the transmitter;
receiving display data from the remote computer in response to the access request using the receiver;
receiving user input data in response to the display data; and
sending the user input data to the remote computer using the transmitter.

10. The method of claim 9, further comprising sending the access request to the remote computer and receiving the display data from the remote computer via a cellular network.

11. The method of claim 10, wherein the step of sending the access request to the remote computer comprises calling a phone number associated with the remote computer via the cellular network.

12. The method of claim 9, further comprising sending the received display data to a video adapter for display on an external display device.

13. The method of claim 12, further comprising:
generating display data identifying a plurality of remote computers; and
sending the generated display data to the video adapter for display on the display device.

14. The method of claim 13, further comprising:
receiving a user selection; and
initiating a remote computing session with one of the plurality of remote computers based on the received user selection.

15. The method of claim 14, further comprising:
detecting a presence of the video adapter; and
automatically sending the generated display data to the video adapter upon detecting the presence of the video adapter.

16. The method of claim 9, further comprising:
accessing the remote computer through a wireless adapter;
receiving a mode selection from a user; and
sending a command to the wireless adapter to operate in a remote computer access mode or a mobile phone mode based on the mode selection.

17. A wireless mobile device, comprising:
means for receiving;
means for transmitting;
means for sending an access request to a remote computer to initiate a remote access session with the remote computer using the means for transmitting;
means for receiving display data from the remote computer in response to the access request using the means for receiving;
means for receiving user input data in response to the display data; and
means for sending the user input data to the remote computer using the transmitter.

18. The wireless mobile device of claim 17, further comprising means for sending the access request to the remote computer and receiving the display data from the remote computer via a cellular network.

19. The wireless mobile device of claim 18, wherein the means for sending the access request to the remote computer comprises means for calling a phone number associated with the remote computer via the cellular network.

20. The wireless mobile device of claim 17, further comprising means for sending the received display data to a video adapter for display on an external display device.

21. The wireless mobile device of claim 20, further comprising:
means for generating display data identifying a plurality of remote computers; and
means for sending the generated display data to the video adapter for display on the display device.

22. The wireless mobile device of claim 21, further comprising:
means for receiving a user selection; and
means for initiating a remote computing session with one of the plurality of remote computers based on the received user selection.

23. The wireless mobile device of claim 21, further comprising:
means for detecting a presence of the video adapter; and
means for automatically sending the generated display data to the video adapter upon detecting the presence of the video adapter.

24. The wireless mobile device of claim 17, further comprising:
means for accessing the remote computer through a wireless adapter;
means for receiving a mode selection from a user; and
means for sending a command to the wireless adapter to operate in a remote computer access mode or a mobile phone mode based on the mode selection.

25. A machine-readable medium comprising instructions executable by a processing system in an electronic device, the instructions comprising code for:
sending an access request to the remote computer to initiate a remote access session with the remote computer using a transmitter;
receiving display data from the remote computer in response to the access request using a receiver;
receiving user input data in response to the display data; and
sending the user input data to the remote computer using the transmitter.

26. The machine-readable-medium of claim 25, wherein the instructions further comprise code for sending the access request to the remote computer and receiving the display data from the remote computer via a cellular network.

27. The machine-readable-medium of claim 26, wherein the code for sending the access request to the remote computer comprises code for calling a phone number associated with the remote computer via the cellular network.

28. The machine-readable-medium of claim 25, wherein the instructions further comprise code for sending the received display data to a video adapter for display on an external display device.

29. The machine-readable-medium of claim 28, wherein the instructions further comprise code for:
generating display data identifying a plurality of remote computers; and
sending the generated display data to the video adapter for display on the display device.

30. The machine-readable-medium of claim 29, wherein the instructions further comprise code for:
receiving a user selection; and
initiating a remote computing session with one of the plurality of remote computers based on the received user selection.

31. The machine-readable-medium of claim 29, wherein the instructions further comprise code for:
detecting a presence of the video adapter; and
automatically sending the generated display data to the video adapter upon detecting the presence of the video adapter.

32. The machine-readable-medium of claim 25, wherein the instructions further comprise code for:
accessing the remote computer through a wireless adapter;
receiving a mode selection from a user; and
sending a command to the wireless adapter to operate in a remote computer access mode or a mobile phone mode based on the mode selection.

33. A system for providing remote computer access, comprising
a receiver;
a transmitter; and
a processor configured to perform steps for providing remote access to a computer, the steps comprising:
receiving an access request from a wireless mobile device using the receiver;
sending display data from the computer to the wireless mobile device in response to the access request using the transmitter;
receiving user input data from the wireless mobile device in response to the display data using the receiver; and
sending the received user data to the computer.

34. The system of claim 33, wherein the processor is configured to receive the access request via a cellular network.

35. The system of claim 34, wherein the step of receiving the access request comprises answering a phone call initiated by the wireless mobile device via the cellular network.

36. The system of claim 35, wherein the processor is configured to receive a command from the wireless mobile device and to operate in a remote computer access mode or a mobile phone mode based on the received command.

37. The system of claim 33, wherein the steps performed by the processor further comprise detecting whether a computer is turned off, and upon detecting that the computer is turned off, sending a wakeup signal to a power device in response to the access request to turn on the computer.

38. The system of claim 33, wherein the steps performed by the processor further comprise sending a wakeup signal to a power device in response to the access request to turn on a computer.

39. A method for providing remote access to a computer, comprising receiving an access request from a wireless mobile device using a receiver;
sending display data from the computer to the wireless mobile device in response to the access request using a transmitter;
receiving user input data from the wireless mobile device in response to the display data using the receiver; and
sending the received user input data to the computer.

40. The method of claim 39, further comprising receiving the access request via a cellular network.

41. The method of claim 40, wherein the step of receiving the access request comprises answering a phone call initiated by the wireless mobile device via the cellular network.

42. The method of claim 41, further comprising:
receiving a command from the wireless mobile device; and
operating in a remote computer access mode or a mobile phone mode based on the received command.

43. The method of claim 39, further comprising sending a wakeup signal to a power device in response to the access request to turn on a computer.

44. The method of claim 39, further comprising:
detecting whether a computer is turned off; and
upon detecting that the computer is turned off, sending a wakeup signal to a power device in response to the access request to turn on the computer.

45. A system for providing remote access to a computer, comprising means for receiving an access request from a wireless mobile device using a receiver;
means for sending display data from the computer to the wireless mobile device in response to the access request using a transmitter;
means for receiving user input data from the wireless mobile device in response to the display data using the receiver; and
means for sending the received user input data to the computer.

46. The system of claim 45, further comprising means for receiving the access request via a cellular network.

47. The system of claim 46, wherein the means for receiving the access request comprises means for answering a phone call initiated by the wireless mobile device via the cellular network.

48. The system of claim 47, further comprising:
means for receiving a command from the wireless mobile device; and
means for operating in a remote computer access mode or a mobile phone mode based on the received command.

49. The system of claim 45, further comprising means for sending a wakeup signal to a power device in response to the access request to turn on a computer.

50. The system of claim 45, further comprising:
means for detecting whether a computer is turned off; and
upon detecting that the computer is turned off, means for sending a wakeup signal to a power device in response to the access request to turn on the computer.

51. A machine-readable medium comprising instructions executable by a processing system in an electronic device, the instructions comprising code for:
receiving an access request from a wireless mobile device using a receiver;
sending display data from the computer to the wireless mobile device in response to the access request using a transmitter;
receiving user input data from the wireless mobile device in response to the display data using the receiver; and
sending the received user input data to the computer.

52. The machine-readable-medium of claim 51, wherein the instructions further comprise code for receiving the access request via a cellular network.

53. The machine-readable-medium of claim 52, wherein the code for receiving the access request comprises code for answering a phone call initiated by the wireless mobile device via the cellular network.

54. The machine-readable-medium of claim 53, wherein the instructions further comprise code for:
receiving a command from the wireless mobile device; and
operating in a remote computer access mode or a mobile phone mode based on the received command.

55. The machine-readable-medium of claim 51, wherein the instructions further comprise code for sending a wakeup signal to a power device in response to the access request to turn on a computer.

56. The machine-readable-medium of claim 51, wherein the instructions further comprise code for:
detecting whether a computer is turned off; and
upon detecting that the computer is turned off, sending a wakeup signal to a power device in response to the access request to turn on the computer.
